(19) United States
(12) Patent Application Publication
(10) Pub. No.: US 2026/0092699 A1
(43) Pub. Date: Apr. 2, 2026

(54) LUMINAIRE AND METHOD OF MANUFACTURING A LUMINAIRE

(71) Applicant: SIGNIFY HOLDING B.V., EINDHOVEN (NL)

(72) Inventors: BO CAI, SHANGHAI (CN); HUAIZHOU LIAO, SHANGHAI (CN); ZHONG HUANH, SONGIIANG (CN); MIAO YU, SHANGHAI (CN)

(21) Appl. No.: 19/111,701

(22) PCT Filed: Sep. 14, 2023
(86) PCT No.: PCT/EP2023/075325

§ 371 Date: Mar. 13, 2025

(30) Foreign Application Priority Data
Sep. 16, 2022 (WO) PCT/CN2022/119308
Nov. 3, 2022 (EP) 22205224.3

(51) Int. Cl. F21V 23/06; F21K 9/90; F21S 8/08; F21V 23/00; F21V 23/04; F21V 31/00; F21W 131/103; F21Y 115/10; H05B 47/13; H05B 47/19

(52) U.S. Cl. CPC F21V 23/06; F21K 9/90; F21S 8/086; F21V 23/006; F21V 23/009; F21V 23/045; F21V 23/0471; F21V 31/005; H05B 47/13; H05B 47/19; F21W 2131/103; F21Y 2115/10

(57) ABSTRACT

A luminaire comprises an outer housing, a main circuit board mounted inside the outer housing, a luminaire driver mounted on the main circuit board and a light source attached to the outer housing from the outside of the outer housing. The light source comprises a first push fit connector portion which extends into the main housing and the main circuit board comprises a second push fit connector portion which engages with the first push fit connector portion when the main circuit board, outer housing and light source are assembled to provide an electrical connection between the main circuit board and the light source.

### FIELD OF THE INVENTION

The invention relates to the assembly of luminaires. In particular, the invention relates to the automatic assembly of road luminaires.

### BACKGROUND OF THE INVENTION

The fourth industrial revolution, or industry 4.0, is a concept which encompasses the recent rapid change in technology. One such change involves the ever-more popular trend towards automated manufacturing and assembly of parts.

For example, automated robots are being used in the manufacturing of products. However, in order for the robots to be able to accurately and consistently manufacture the products, these products often have to be designed in a way which takes account of the manufacturing capability of the robots.

Road luminaires have been identified as a product which would benefit from automated manufacturing. However, an issue with this is that the road luminaires have many components (e.g. light sources, lighting drivers, sensors etc.) which all need to be interconnected using wires. It can be difficult to use automated robots for the wiring process as it is difficult to predict the precise positioning of the wires when the robot moves them during manufacturing.

Thus, there is a need to improve the design of luminaires to facilitate automated manufacturing.

### SUMMARY OF THE INVENTION

The invention is defined by the claims.

According to examples in accordance with an aspect of the invention, there is provided a luminaire comprising:

an outer housing;

a main circuit board mounted inside the outer housing;

a luminaire driver mounted on the main circuit board;

a light source attached to the outer housing from the outside of the outer housing; and

a pluggable connector plugged to the luminaire driver and to the main circuit board, for making an electrical connection between the luminaire driver and the main circuit board;

wherein the light source comprises a first push fit connector portion which extends into the main housing, and the main circuit board comprises a second push fit connector portion which engages with the first push fit connector portion, when the main circuit board, outer housing and light source are assembled, thereby to provide an electrical connection between the main circuit board and the light source.

The pluggable connector is a push fit component, which can thus be installed by a robotic arm (in the same direction as the assembly of the light source and main circuit board), avoiding the need to route and connect wires between the luminaire driver and the main circuit board.

Product manufacturing/assembling using robotic arms, or similar, provides quicker and more efficient assembly of the product. However, for road luminaires, the components used and the way they are connected makes it difficult for a robotic arm to assemble the product. It has been realized that the wiring process of road luminaires is what makes the robotic assembly difficult. In particular, product placement along one axis (i.e. the z-axis direction, if the circuit board lies in the x-y plane) on a circuit board is simple to achieve, whereas more complex robotic movements would be required for example to feed wires through openings which are not aligned with the z-axis direction.

Thus, it is proposed to use a main circuit board to connect all of the components together instead of wires. The connection between the light source and the main circuit board is then achieved by a push fit connection, such as a male and female push fit pin connection. This can be achieved more simply using a robotic arm that handling wires.

Similarly, other components within the outer housing can connect to the main circuit board by push fit connectors which can be fitted by robotic placement.

The only wires that need to be routed are then the external power lines to provide power to the main circuit board.

Thus, the use of a main circuit board enables the robotic arm to quickly and efficiently assemble the road luminaire, and the mechanical assembly automatically creates the electrical connection between the light source and the main circuit board.

By mounting the light source from outside the outer housing, the assembly of the housing itself provides the electrical connection between the main circuit board and the light source, rather than having to pre-assemble the light source with the main circuit board.

Additionally, the use of a main circuit board may also make it easier for the luminaire to be maintained because there is no longer a mix of wires connecting all the different components which avoids confusion during maintenance.

The first push fit connector portion for example comprises one or more pins and the second push fit connector portion then comprises a socket.

The pin and socket arrangement enables the light source to be correctly aligned with the main circuit board when the pins are aligned with the socket. The pins may extend through holes through the housing which allows the pins to go through the housing and connect to the main circuit board.

The main circuit board is for example mounted on an internal first face of the outer housing and the light source is attached to an external second face of the outer housing. The main circuit board and the light source are for example mounted in opposite directions, and the robotic assembly system enables component placement in these two opposite directions (e.g. the positive and negative z-axis direction, where the main circuit board lies in the x-y plane).

The luminaire may further comprise a motion sensor within the outer housing and connected to the main circuit board, wherein the motion sensor is configured to sense motion outside the outer housing.

Motion sensors can be used to sense when there is activity nearby and turn the light on when such activity is detected. The motion sensor senses motion outside the housing whilst being placed within the housing and connected to the main circuit board.

The motion sensor may be mounted to the first face of the outer housing when the luminaire is assembled. Additionally, the motion sensor may connect to the main circuit with a push fit coupling. The luminaire may further comprise a pluggable connector plugged to the motion sensor and to the main circuit board, for making an electrical connection between the motion sensor and the main circuit board.

The main circuit board for example further comprises a wireless signal receiver. The wireless signal receiver is for example for receiving a coded light signal.

The wireless signal receiver may be mounted to the first face of the outer housing when the luminaire is assembled. In this way, the wireless signal receiver can be positioned at a window of the outer housing, or project through the outer housing.

The luminaire for example further comprises a pluggable connector plugged to the wireless signal receiver and to the main circuit board, for making an electrical connection between the wireless signal receiver and the main circuit board.

The outer housing for example comprises a housing body and a housing cover and wherein the main circuit board is mounted to the housing body. The housing body may be considered to be a base part.

An O-ring is for example provided between the housing body and the housing cover for waterproofing the housing.

The luminaire may be a road luminaire.

The invention also provides a method for manufacturing a luminaire, the method comprising controlling a robotic arm to follow manufacturing instructions comprising:

placing a main circuit board within an outer housing;

positioning a luminaire driver on the main circuit board before or after placing the main circuit board within the outer housing; and

attaching a light source to the outer housing from the outside of the outer housing,

wherein the attaching of the light source provides an electrical connection between the light source and the main circuit board by a push fit connection between a first push fit connector portion of the light source which extends into the outer housing, and a second push fit connector portion of the main circuit board.

The use of a push fit connection avoids the need to route wires between the light source and the luminaire driver, because the main circuit board functions as an intermediate part to which push fit connections can be made. These push fit connections can all be made using robotic arm motion along a single axis.

The main circuit board is for example mounted on an internal first face of the outer housing and the light source is attached to an external second face of the outer housing.

Having the main circuit board and the light source mounted/attached to opposite faces of the outer housing means they can be vertically aligned consistently by the robotic arm. Additionally, this is a way to enable the push fit connector portion of the main circuit board to be accurately aligned with the push fit connector portion of the light source.

The manufacturing instructions for example comprise:

attaching the luminaire driver to the main circuit board, after placing the main circuit board within the outer housing; and

applying a pluggable connector to electrically connect the luminaire driver to the main circuit board.

Thus, the main circuit board is first positioned within the outer housing, and then the other components are attached mechanically to the main circuit board or to the housing, and pluggable electrical connectors may be used to make electrical connections.

The manufacturing instructions for example further comprise aligning the first and second push fit connector portions before attaching the light source. For example, the manufacturing instructions may comprise aligning one or more pins of the first push fit connector portion with a socket of the second push fit connector portion. After these alignments, the connection can be made with single-axis movement.

The manufacturing instructions for example further comprise:

placing a motion sensor within the outer housing, wherein the motion sensor is configured to sense motion outside the outer housing; and

applying a pluggable connector to electrically connect the motion sensor to the main circuit board.

The manufacturing instructions may further comprise:

placing a wireless receiver within the outer housing; and

applying a pluggable connector to electrically connect the wireless receiver to the main circuit board.

The outer housing for example comprises a housing body and a housing cover and the manufacturing instructions further comprise closing the housing by fastening the housing cover to the housing body and waterproofing the housing.

The positioning of the luminaire driver on the main circuit board, the positioning of the main circuit board within the outer housing and the attaching of the light source to the outer housing may each comprise component placements in a direction perpendicular to the main circuit board. Different components may be placed in opposite directions, e.g. in the +z and-z axis directions.

The pluggable connectors may also be applied in the same z-axis direction.

The invention also provides a computer program comprising computer program code means which is adapted, when said program is run on computer of a robotic arm controller, to implement the method above.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a first step in manufacturing a luminaire;

FIGS. 2 and 3 show a second step in manufacturing the luminaire;

FIG. 4 shows a cross section of the road luminaire during the second step of manufacturing;

FIGS. 5 and 6 show a third step in manufacturing the luminaire;

FIGS. 7 and 8 show a fourth step in manufacturing the luminaire;

FIG. 9 shows a fifth step in manufacturing the luminaire; and

FIG. 10 shows an exploded view of the road luminaire.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a luminaire comprising an outer housing, a main circuit board mounted inside the outer housing, a luminaire driver mounted on the main circuit board and a light source attached to the outer housing from the outside of the outer housing. The light source comprises a first push fit connector portion which extends into the main housing and the main circuit board comprises a second push fit connector portion which engages with the first push fit connector portion when the main circuit board, outer housing and light source are assembled to provide an electrical connection between the main circuit board and the light source.

The luminaire can be advantageously manufactured/assembled using an automated robot. The advantages of automated manufacturing are particularly noticeable in the manufacture of road luminaires. As such, the following example will be given with respect to a road luminaire. However, the same steps and design features may be applied to any type of luminaire.

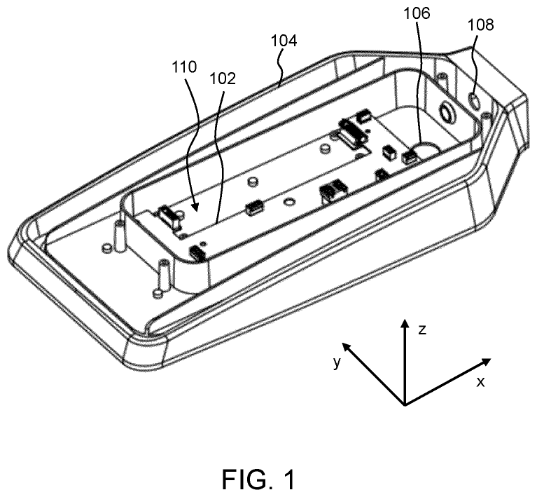

FIG. 1 shows a first step in manufacturing a road luminaire. The first step comprises mounting a main circuit board 102 to an outer housing, in particular to a housing body 104 which may be considered to be a housing base, over which a cover is later applied.

The main circuit board is mounted on a first, internal, face 110 of the housing body 104 and will later be covered by the housing cover such that it is mounted within the outer housing. The housing body 104 comprises a first through-hole 106 for mounting a sensor (not shown) and a second through-hole 108 for the power supply wires (not shown).

The main circuit board is intended to replace the majority of the wires which are typically used in a road luminaire, thereby enabling a robotic arm to manufacture the road luminaire accurately and consistently. A robotic arm is readily capable of mounting the main circuit board 102 on the housing body 104 (e.g. fastening the main circuit board 102 to the housing with screws).

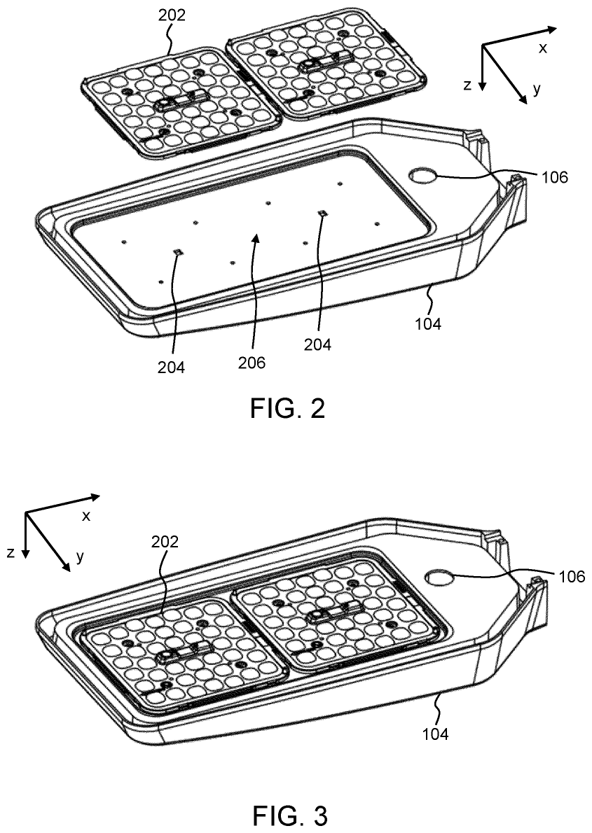

FIGS. 2 and 3 show a second step in manufacturing a road luminaire. The second step comprises attaching a light source 202 to the housing body 104. The light source is for example one or more LED panels. In particular, the light source 202 is attached to a second, external, face 206 of the housing body 104. The second face 206 is opposite the first face 110 shown in FIG. 1. As such, the light source 202 can be attached to the outside of the housing body whilst being aligned with the main circuit board (not shown) which is inside the outer housing.

In this way, the housing body is sandwiched between the light source and the main circuit board, and an electrical connection between the light source and the main circuit board passes through the housing body, instead of the connections all being fully internal to the outer housing. This design facilitates a robotic assembly of the luminaire.

The main circuit board and the light source are positioned by movement in a direction perpendicular to a plane of the main circuit board. For example, the main circuit board may be considered to lie in an x-y plane, and the movement of components required to perform the assembly is then in the z-axis direction, in particular with movement of different parts being in one or other of the opposite z-axis directions (i.e. +z or −z directions).

Additionally, the first through-hole 106 enables the sensor to be mounted inside the housing on the first face whilst a sensing portion of the sensor can extend past the second face 206 to sense e.g. movement outside the housing body. The sensing portion may alternatively be positioned against a sensing window of the outer housing.

FIG. 2 shows the road luminaire before the light source 202 is attached to the housing body 104. The second face 206 of the housing body comprises two through-holes such that two push fit connector portions 204 of the main circuit board are visible from the second face 206. These two push fit connector portions 204 are to be aligned with push fit connector portions of the light source 202 (not shown). This enables the light source 202 to be electrically connected to the main circuit board without the need of wires, and by a simple push fits connection along the z-axis direction.

The robotic arm aligns the light source 202 with the through-holes 204, thus being aligned with the main circuit board, before being attached to the housing body 104 (e.g. using screws). The robotic arm can accurately attach the light source 202 to the housing body 104 using only z-axis direction placement (i.e. align the light source 202 and move it towards the housing body 104).

FIG. 3 shows the road luminaire after the light source 202 is attached to the housing body 104. In this case the push fit connector portions of the light source 202 are now connected with the push fit connector portions 204 of the main circuit board shown in FIG. 2.

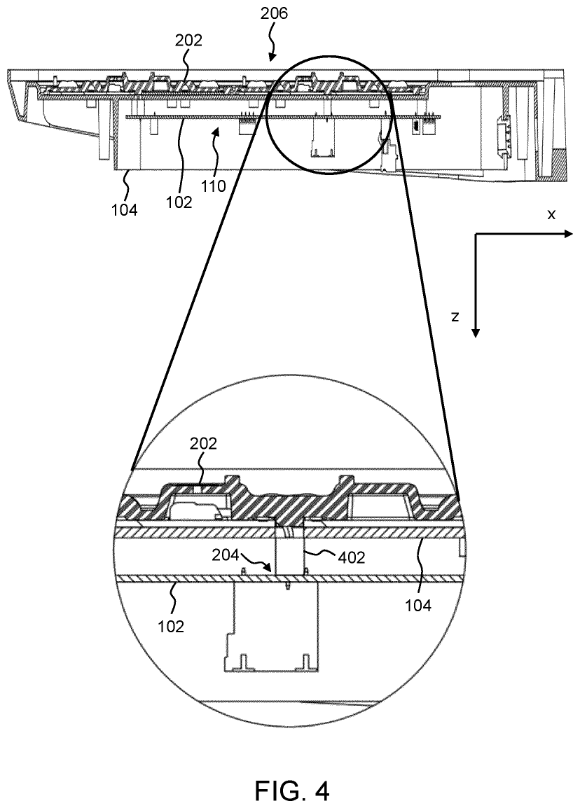

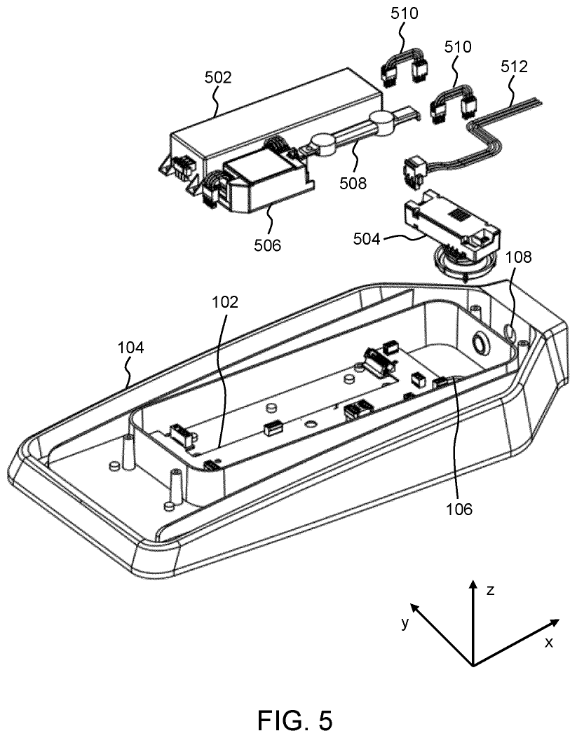

FIG. 4 shows a cross section of the road luminaire during the second step of manufacturing. The top cross section shows the main circuit board 102 mounted on the first face 110 of the housing body 104 and the light source 202 mounted on the second face 206 of the housing body 104.

The bottom cross section shows an enlarged view of a portion of the top cross section. In particular, the bottom cross section shows the push fit connector portion 204 of the main circuit board 102 and the push fit connector portion 402 of the light source 202. The push fit connector portion 402 of the light source 202 is a pin and the push fit connector portion 204 of the main circuit board 102 is a female socket connector. The pin 402 can be pushed into the female connector 204 to provide an electrical connection between the light source 202 and the main circuit board 102. The pin 402 is provided through a through-hole of the housing 104.

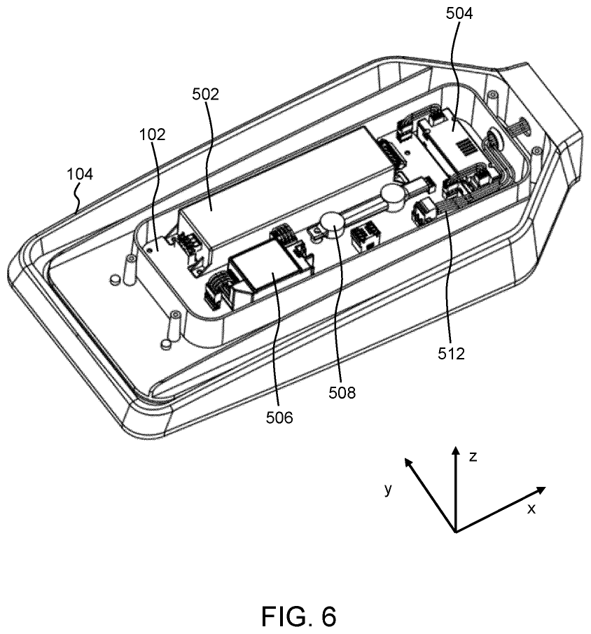

FIGS. 5 and 6 show a third step in manufacturing the road luminaire. In the third step, additional components are added to the road luminaire. In particular, these components are electrically connected to the main circuit board 102. These components include a lighting driver 502, a passive infra-red (PIR) sensor 504, a wireless receiver 506 and a surge protection device 508. These components are connected to the main circuit board 102 using pluggable connectors (e.g. connectors 510 for the PIR sensor 504). The wireless receiver is for example for receiving coded light signals. However, it may instead be for receiving other wireless signals such as short wave RF signals (e.g. Bluetooth or Wifi), to enable wireless remote control of the luminaire functions.

The components are preferably also mounted in the z-axis direction. They may be mounted to the main circuit board, or they may be mounted to the housing body. The initial mountings are for example only mechanical. Once mechanically mounted, electrical connections may be provided as pluggable electrical connectors. These pluggable electrical connectors are also plugged in the z-axis direction. This can be seen in FIG. 5 for the pluggable connectors 510. Thus all, or nearly all, components can be mechanically positioned and electrically connected using only z-axis (+z or −z) component movements. The mechanical position of some components have however also implement an electrical connection, but using a push fit electrical connector, as is used between the light source and the main circuit board.

In this particular example, the PIR sensor 504 is mounted to the housing body 104, with a sensing portion of the PIR sensor 504 extending past the first through-hole 106 of the housing body 104, whereas the wireless receiver and surge protection device are mounted on the main circuit board. However, the components may be mounted with different components fixed to the outer housing and different components fixed to the main circuit board.

In this example, the power source wires 512 are the only components shown which may need to be manually connected, as the robotic arm may find it difficult to feed the power source wires 512 through the second through-hole 108.

FIG. 5 shows the components before they are connected to the main circuit board 102. FIG. 6 shows the components after they are connected to the main circuit board 102. As can be seen, all of the components apart from the power source wires 512 can be connected to the main circuit board by the robotic arm (i.e. aligning each component, placing it on the housing body 104 or the main circuit board 102 and connecting the components to the main circuit board 102 using pluggable connectors such as the connectors 510 for the PIR sensor 504.

The connectors may use relatively short cables with male/female connectors at the end as the relatively short cables are manageable for the robotic arm. Alternatively, the components may have male/female connectors which are aligned with the corresponding female/male connectors on the main circuit board 102, and then comprise a single block connector.

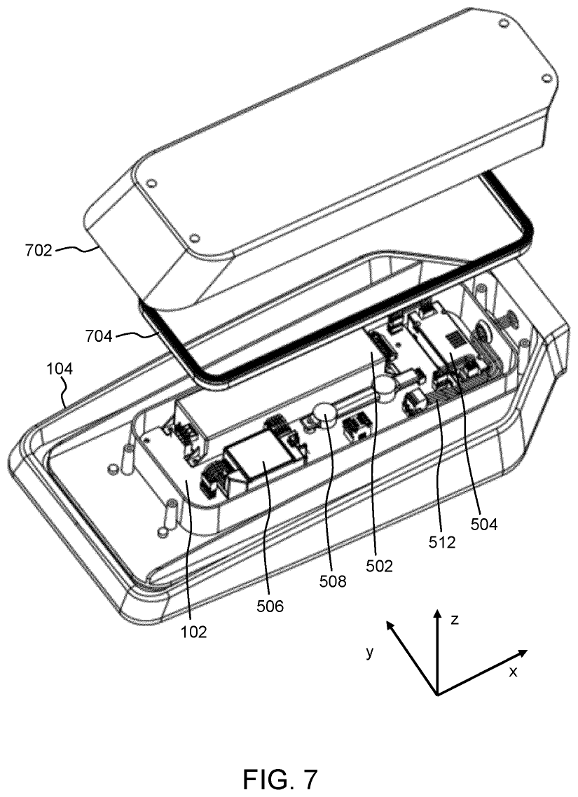

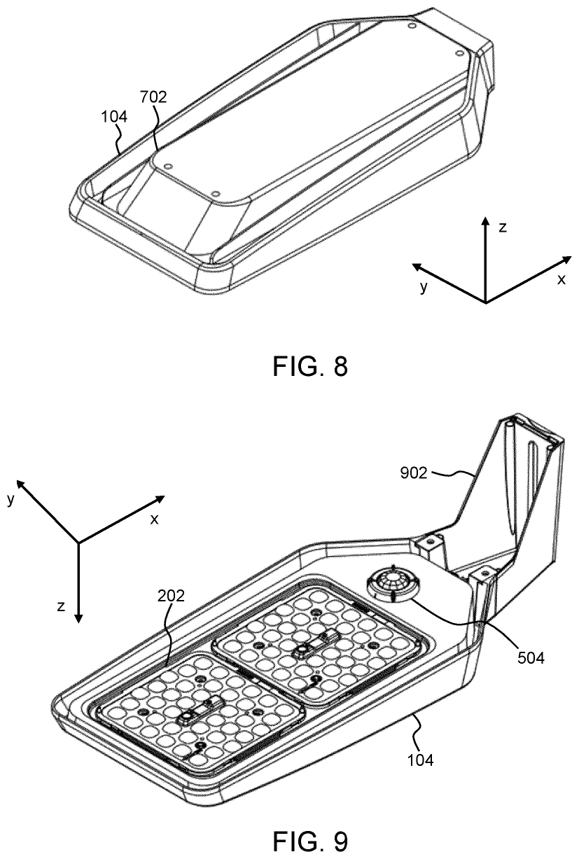

FIGS. 7 and 8 show a fourth step in manufacturing the road luminaire. The fourth step comprises adding a housing cover 702 with an O-ring (or gasket) 704 between the housing body 104 and the housing cover 104. The O-ring 704 ensures the inside of the housing (formed by the housing body 104 and the housing cover 702) is sealed and waterproof. The inside of the housing has the main circuit board 102 mounted on the first face of the housing body and the components (i.e. the lighting driver 502, the PIR sensor 504, the coded receiver 506, the surge protection device 508 and the power source wire 512). As such, the electrical components of the road luminaire are protected from the environment (e.g. rain, dust etc.). The housing cover 702 can be attached to the housing body 104 with screws to form the housing of the road luminaire.

Of course, the robotic arm will be readily capable of assembling the O-ring 704 and the housing cover 702 by aligning them with the housing body 104 and fastening them to the housing body with e.g. screws.

FIG. 7 shows the housing cover 702 and O-ring 704 before they are assembled to the remainder of the road luminaire. FIG. 8 shows the road luminaire after the housing body 104, housing cover 702 and O-ring are assembled together.

FIG. 9 shows a fifth step in manufacturing a road luminaire. The fifth step comprises adding a mounting bracket 902 to the road luminaire such that it can be mounted e.g. to a pole near the road.

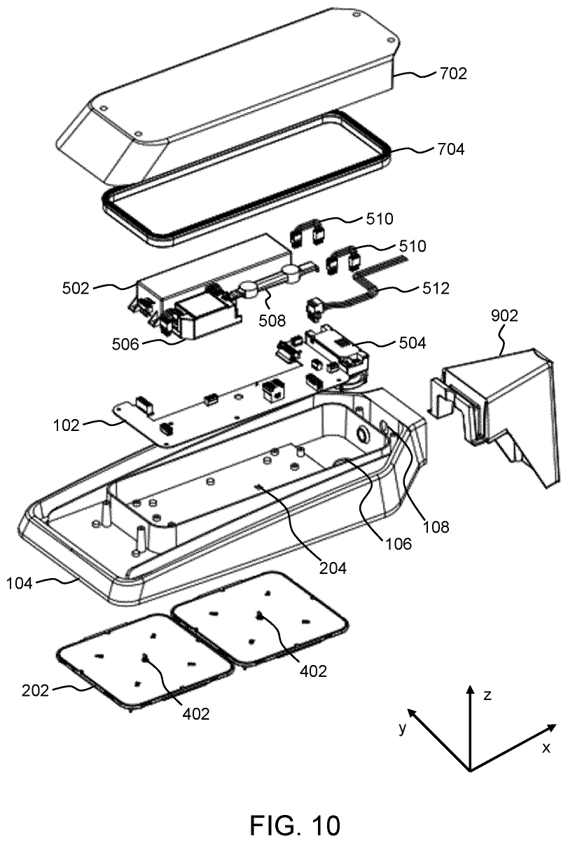

FIG. 10 shows an exploded view of the road luminaire, showing all components discussed above.

The method of assembly described comprises five steps. However, there is no reason these steps must be done in the exact order provided. For example, some of the components added in the third step could be attached to the main circuit board 102 before the main circuit board 102 is mounted to the housing body 104.

The robotic arm follows manufacturing instructions to manufacture/assemble the road luminaire. These instructions may be provided in a processor/controller configured to instruct the robotic arm to perform the manufacturing instructions.

The skilled person would be readily capable of developing a controller for carrying out any herein described method. The controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform the required functions. Various storage media may be fixed within a processor or controller or may be transportable, such that the one or more programs stored thereon can be loaded into a processor or controller.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a”or “an”does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A luminaire comprising:
an outer housing ,
a main circuit board ) mounted inside the outer housing;
a luminaire driver mounted on the main circuit board;
a light source attached to the outer housing from the outside of the outer housing; and
a pluggable connector plugged to the luminaire driver and to the main circuit board, for making an electrical connection between the luminaire driver and the main circuit board;
wherein the light source comprises a first push fit connector portion which extends into the outer housing, and the main circuit board comprises a second push fit connector portion which engages with the first push fit connector portion, when the main circuit board, outer housing and light source are assembled, thereby to provide an electrical connection between the main circuit board and the light source.

2. The luminaire of claim 1, wherein the first push fit connector portion comprises one or more pins and the second push fit connector portion comprises a socket.

3. The luminaire of claim 1, wherein the main circuit board is mounted on an internal first face of the outer housing and the light source is attached to an external second face of the outer housing.

4. The luminaire of claim 1, further comprising a motion sensor within the outer housing and connected to the main circuit board, wherein the motion sensor is configured to sense motion outside the outer housing.

5. The luminaire of claim 1, further comprising a wireless signal receiver mounted on the main circuit board, and a pluggable connector plugged to the wireless signal receiver and to the main circuit board, for making an electrical connection between the wireless signal receiver and the main circuit board.

6. The luminaire of claim wherein the outer housing comprises a housing body and a housing cover and wherein the main circuit board is mounted to the housing body.

7. The luminaire of claim comprising a road luminaire.

8. A method for manufacturing a luminaire, the method comprising controlling a robotic arm to follow manufacturing instructions comprising:
placing a main circuit board within an outer housing
positioning a luminaire driver on the main circuit board before or after placing the main circuit board within the outer housing; and
attaching a light source to the outer housing from the outside of the outer housing,
wherein the attaching of the light source provides an electrical connection between the light source and the main circuit board by a push fit connection between a first push fit connector portion of the light source which extends into the outer housing, and a second push fit connector portion of the main circuit board.

9. The method of claim 8, wherein the main circuit board is mounted on an internal first face of the outer housing and the light source is attached to an external second face of the outer housing.

10. The method of claim wherein the manufacturing instructions comprise:
attaching the luminaire driver to the main circuit board, after placing the main circuit board within the outer housing; and
applying a pluggable connector to electrically connect the luminaire driver to the main circuit board.

11. The method of claim wherein the manufacturing instructions further comprise:
placing a motion sensor within the outer housing, wherein the motion sensor is configured to sense motion outside the outer housing; and
applying a pluggable connector to electrically connect the motion sensor to the main circuit board.

12. The method of claim wherein the manufacturing instructions further comprise:
placing a wireless receiver within the outer housing; and
applying a pluggable connector to electrically connect the wireless receiver to the main circuit board.

13. The method of claim wherein the positioning of the luminaire driver on the main circuit board, the positioning of the main circuit board within the outer housing and the attaching of the light source to the outer housing each comprise component placements along both opposite directions perpendicular to the main circuit board.

14. A computer program comprising computer program code means which is adapted, when said program is run on a computer of a robotic arm controller, to implement the method of claim 8.
